(19) United States
(12) Patent Application Publication
(10) Pub. No.: US 2025/0036066 A1
(43) Pub. Date: Jan. 30, 2025

(54) DEVELOPING DEVICE AND IMAGE FORMING APPARATUS

(71) Applicant: FUJIFILM Business Innovation Corp., Tokyo (JP)

(72) Inventor: Masayuki SHIMODA, Kanagawa (JP)

(73) Assignee: FUJIFILM Business Innovation Corp., Tokyo (JP)

(21) Appl. No.: 18/429,895

(22) Filed: Feb. 1, 2024

(30) Foreign Application Priority Data
Jul. 28, 2023 (JP) 2023-122977

(51) Int. Cl. G03G 21/10; G03G 15/08; G03G 21/12

(52) U.S. Cl. CPC G03G 21/105; G03G 15/08; G03G 21/12

(57) ABSTRACT

A developing device includes: a housing that stores a developer; a developer holding unit that is disposed at an opening portion of the housing that faces an image holding body and that rotates while holding the developer; an exhaust passage through which air in the housing is discharged to outside; and a suction passage through which the developer that leaks out from the opening portion of the housing is sucked. The exhaust passage and the suction passage are disposed at different positions along an axial direction of the developer holding unit.

### CROSS-REFERENCE TO RELATED APPLICATIONS

This application is based on and claims priority under 35 USC 119 from Japanese Patent Application No. 2023-122977 filed Jul. 28, 2023.

### BACKGROUND

### (i) Technical Field

The present disclosure relates to a developing device and an image forming apparatus.

### (ii) Related Art

There have hitherto been proposed techniques related to developing devices, such as those disclosed in Japanese Unexamined Patent Application Publication No. 2018-049118, Japanese Unexamined Patent Application Publication No. 8-220882, and Japanese Unexamined Patent Application Publication No. 2013-125148, for example.

Japanese Unexamined Patent Application Publication No. 2018-049118 describes a developing device including: a developer storage container that stores a developer; a developer holding body disposed at an opening portion of the developer storage container to rotate opposite to an image holding body to hold the developer; an exhaust passage through which air in the developer storage container is discharged to the outside; a capturing member that captures a toner in the exhaust air passing through the exhaust passage; and a closing member that is held at its base end by the developer storage container and that is sandwiched at its tip by the developer storage container and the developer held by the developer holding body to close a gap on the downstream side of the opening portion along the rotational direction of the developer holding body.

Japanese Unexamined Patent Application Publication No. 8-220882 describes a developing device in which a vent is formed along the bottom wall of a developing tank that stores a developer carrier and which is provided with a suction unit that sucks air from a duct formed in the vent via a toner filter.

Japanese Unexamined Patent Application Publication No. 2013-125148 describes a device including: a duct that is provided above a developing device and that communicates with an air flow-out path; an exhaust unit that generates an air flow in the duct; and a filter that is disposed on the air flow discharge side of the duct and that traps a toner having passed through the inside of the duct together with air in a developing container.

### SUMMARY

Aspects of non-limiting embodiments of the present disclosure relate to discharging air in a developing device and sucking a scattered toner at the same time while suppressing an increase in size of the developing device compared to a case where exhaust passages and suction passages are all disposed at the same position along the axial direction of a developer holding unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including: a housing that stores a developer; a developer holding unit that is disposed at an opening portion of the housing that faces an image holding body and that rotates while holding the developer; an exhaust passage through which air in the housing is discharged to outside; and a suction passage through which the developer that leaks out from the opening portion of the housing is sucked, in which the exhaust passage and the suction passage are disposed at different positions along an axial direction of the developer holding unit.

### BRIEF DESCRIPTION OF THE DRAWINGS

Exemplary embodiments of the present disclosure will be described in detail based on the following figures, wherein:

FIG. 1 illustrates the overall configuration of an image forming apparatus including a developing device according to a first exemplary embodiment of this disclosure;

FIG. 2 illustrates the configuration of an image forming unit of the image forming apparatus including the developing device according to the first exemplary embodiment of this disclosure;

FIG. 3 is a vertical sectional view illustrating the configuration of the developing device according to the first exemplary embodiment of this disclosure;

FIG. 4 is a back view illustrating the configuration of the developing device according to the first exemplary embodiment of this disclosure;

FIG. 5 is a vertical sectional view illustrating the configuration of the developing device according to the first exemplary embodiment of this disclosure;

FIG. 6 is a back view illustrating the configuration of the developing device according to the first exemplary embodiment of this disclosure with a passage forming member removed;

FIG. 7 is a perspective view illustrating the configuration of a portion of the developing device according to the first exemplary embodiment of this disclosure;

FIG. 8 is a perspective view illustrating the arrangement of the developing device and a suction duct;

FIG. 9 illustrates the function of the developing device according to the first exemplary embodiment of this disclosure;

FIG. 10 illustrates the function of the developing device according to the first exemplary embodiment of this disclosure;

FIG. 11 is a perspective view illustrating the configuration of a portion of a developing device according to a second exemplary embodiment of this disclosure;

FIG. 12 is a perspective view illustrating the configuration of a portion of a developing device according to a third exemplary embodiment of this disclosure; and

FIG. 13 is a back view illustrating the configuration of a developing device according to a fourth exemplary embodiment of this disclosure with a passage forming member removed.

### DETAILED DESCRIPTION

Exemplary embodiments of this disclosure will be described below with reference to the drawings.

### First Exemplary Embodiment

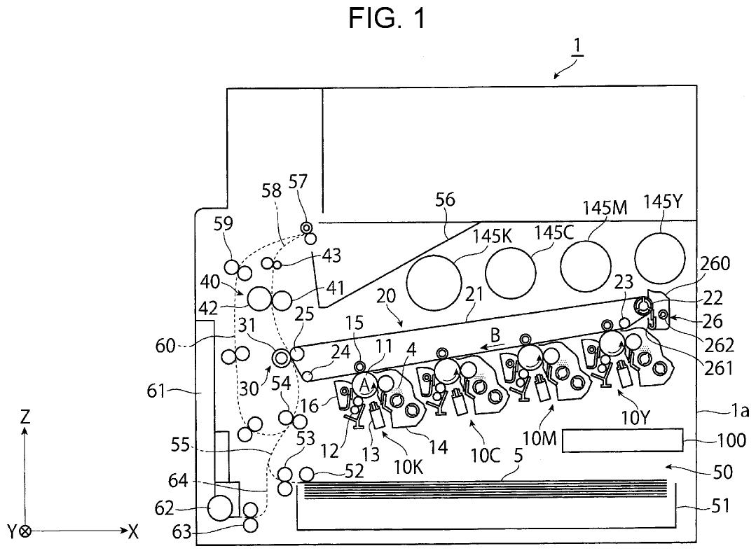

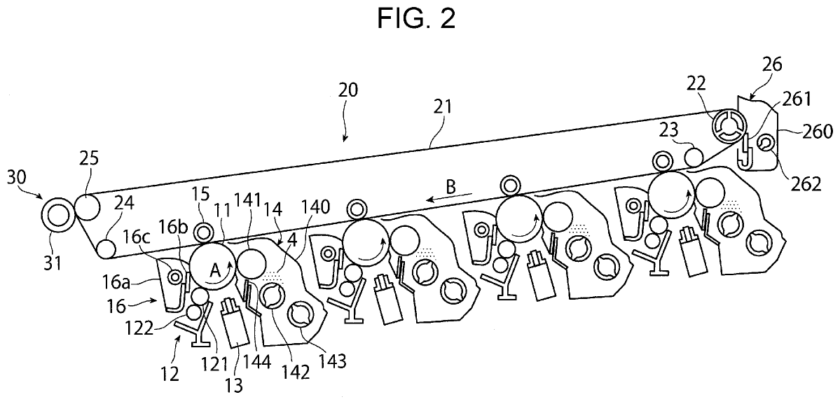

FIGS. 1 and 2 illustrate an image forming apparatus including a developing device according to a first exemplary embodiment. FIG. 1 illustrates an overview of the image forming apparatus, and FIG. 2 illustrates a portion (such as an imaging device) of the image forming apparatus as enlarged. In FIG. 1, symbol X denotes the horizontal direction (width direction) of the image forming apparatus, symbol Y denotes the depth direction of the image forming apparatus, and symbol Z denotes the vertical direction of the image forming apparatus.

### <Overall Configuration of Image Forming Apparatus>

The image forming apparatus 1 according to the first exemplary embodiment is constituted as a color printer, for example. As illustrated in FIG. 1, the image forming apparatus 1 includes, provided inside an apparatus body 1a: a plurality of imaging devices 10 that form toner images to be developed using a toner that constitutes a developer 4; an intermediate transfer device 20 that holds the toner images formed by the imaging devices 10 and transport the toner images finally to a second transfer position at which the toner images are transferred to recording paper 5, as an example of a recording medium, through a second transfer; a paper feeding device 50 that stores and transports the prescribed recording paper 5 to be supplied to the second transfer position of the intermediate transfer device 20; a fixing device 40 that fixes the toner images on the recording paper 5 which have been subjected to the second transfer in the intermediate transfer device 20; etc. The apparatus body 1a of the image forming apparatus 1 is formed from a support structural member, an exterior cover, etc.

The imaging devices 10 are constituted from four imaging devices 10Y, 10M, 10C, and 10K that exclusively form toner images in four colors, namely yellow (Y), magenta (M), cyan (C), and black (K). The four imaging devices 10 (Y, M, C, K) are disposed in the internal space of the apparatus body 1a as arranged in one line in an inclined state. Of the four imaging devices 10 (Y, M, C, K), the imaging device 10Y for yellow (Y) is located at a relatively high position along the vertical direction Z, and the imaging device 10K for black (K) is located at a relatively low position.

As illustrated in FIGS. 1 and 2, the imaging devices 10 (Y, M, C, K) for yellow (Y), magenta (M), cyan (C), and black (K) each include a rotatable photoconductor drum 11 as an example of an image holding unit that holds an electrostatic latent image, and the following devices are principally disposed around the photoconductor drum 11 as an example of a toner image forming unit. The devices include: a charging device 12 that charges a peripheral surface (image holding surface) of the photoconductor drum 11, on which an image may be formed, to a prescribed potential; an exposure device 13 that forms an electrostatic latent image for each color with a potential difference by irradiating the charged peripheral surface of the photoconductor drum 11 with light based on information (signal) on an image; a developing device 14 as an example of a developing unit that develops the electrostatic latent image using a toner of the developer 4 for the corresponding color (Y, M, C, K) to form a toner image; a first transfer device 15 that transfers each toner image to the intermediate transfer device 20; a drum cleaning device 16 that cleans the photoconductor drum 11 by removing attached matter such as a residual toner adhering to the image holding surface of the photoconductor drum 11 after a first transfer; etc.

In the photoconductor drum 11, an image holding surface with a photoconductive layer (photosensitive layer) made of a photosensitive material is formed on the peripheral surface of a cylindrical or circular columnar base material that has been grounded. The photoconductor drum 11 is supported so as to rotate in a direction indicated by the arrow A when power is transmitted from a drive device (not illustrated).

As illustrated in FIG. 2, the charging device 12 includes a contact-type charging roller 121 disposed in contact with the photoconductor drum 11. A cleaning roller 122 is disposed on the back surface of the charging roller 121 to clean the surface of the charging roller 121. A charging voltage is supplied to the charging roller 121 of the charging device 12. When the developing device 14 performs reversal development, a voltage or a current of the same polarity as the charging polarity of the toner supplied from the developing device 14 is supplied as the charging voltage. The charging device 12 may be a non-contact-type charging device such as a scorotron disposed in non-contact with the surface of the photoconductor drum 11.

The exposure device 13 forms an electrostatic latent image by irradiating the peripheral surface of the photoconductor drum 11 after being charged with light formed in accordance with information on an image input to the image forming apparatus 1. Information (signal) on an image input to the image forming apparatus 1 in a desired manner is transmitted to the exposure device 13 when a latent image is to be formed.

The exposure device 13 includes a light emitting diode (LED) print head that forms an electrostatic latent image by irradiating the photoconductor drum 11 with light according to the image information using a plurality of LEDs as light emitting elements arranged along the axial direction of the photoconductor drum 11. The exposure device 13 may perform deflected scanning along the axial direction of the photoconductor drum 11 using laser light formed in accordance with the image information.

The developing device 14 includes, as disposed inside a device housing 140 as an example of a housing in which an opening portion is formed at a position facing the photoconductor drum 11 and a developer storage chamber is formed: a developing roller 141 that holds and transports the developer 4 to a developing region that faces the photoconductor drum 11; an agitation-supply member 142 such as a screw auger that supplies the developer 4 so as to pass through the developing roller 141 while agitating the developer 4; an agitation-transport member 143 such as a screw auger that transports the developer 4 to the agitation-supply member 142 while agitating the developer 4; a layer thickness regulation member 144 that regulates the amount (layer thickness) of the developer held by the developing roller 141; etc. A developing voltage is applied between the developing roller 141 of the developing device 14 and the photoconductor drum 11 by a power supply device (not illustrated). The developer 4 for each color may be a two-part developer containing a non-magnetic toner and a carrier, for example. The configuration of the developing device 14 will be discussed in detail later.

The first transfer device 15 is a contact-type transfer device that includes a first transfer roller that rotates in contact with the periphery of the photoconductor drum 11 via an intermediate transfer belt 21 and that is supplied with a first transfer voltage. A direct-current voltage that exhibits a polarity opposite to the charging polarity of the toner is supplied as the first transfer voltage from a power supply device (not illustrated).

As illustrated in FIG. 2, the drum cleaning device 16 is composed of: a body 16a in the shape of a partially open container; a cleaning plate 16b disposed in contact with the peripheral surface of the photoconductor drum 11 after a first transfer with a prescribed pressure to clean the photoconductor drum 11 by removing attached matter such as a residual toner; a feeding member 16c such as a screw auger that recovers the attached matter such as the toner removed by the cleaning plate 16b and that transports and feeds the attached matter to a recovery system (not illustrated); etc. The cleaning plate 16b may be a plate-like member (e.g. a blade) made of a material such as rubber.

As illustrated in FIG. 1, the intermediate transfer device 20 is disposed at a position above the imaging devices 10 (Y, M, C, K) along the vertical direction Z. As illustrated in FIG. 2, the intermediate transfer device 20 is principally composed of: an intermediate transfer belt 21 that rotates in a direction indicated by the arrow B while passing through a first transfer position between the photoconductor drum 11 and the first transfer device 15; a plurality of belt support rollers 22 to 25 that rotatably hold the intermediate transfer belt 21 by holding the intermediate transfer belt 21 in a desired state from the inner surface; a second transfer device 30 that is disposed on the outer peripheral surface (image holding surface) side of the intermediate transfer belt 21 supported by the belt support rollers 25 to transfer toner images on the intermediate transfer belt 21 to recording paper 5 through a second transfer; and a belt cleaning device 26 that cleans the intermediate transfer belt 21 by removing attached matter such as a residual toner and paper dust attached to the outer peripheral surface of the intermediate transfer belt 21 after passing through the second transfer device 30.

In the first exemplary embodiment, as discussed above, the intermediate transfer device 20 is disposed at a position above the imaging devices 10 (Y, M, C, K) along the vertical direction Z. Therefore, it is difficult to form a clearance between the upper portion of the developing device 14 and the intermediate transfer belt 21 and the upper end of the developing device 14 is inevitably disposed at a position proximate to the intermediate transfer belt 21, because the developing device 14 disposed at the outer periphery of the photoconductor drum 11 transfers a toner image developed onto the photoconductor drum 11 to the intermediate transfer belt 21 of the intermediate transfer device 20 located at a position above the photoconductor drum 11 along the vertical direction Z as illustrated in FIG. 2.

The intermediate transfer belt 21 may be an endless belt manufactured from a material obtained by dispersing a resistance regulating agent etc. such as carbon black in a synthetic resin such as a polyimide resin and a polyamide resin, for example. The belt support roller 22 is constituted as a drive roller rotationally driven by a drive device (not illustrated) and a support roller for the belt cleaning device 26, the belt support roller 23 is constituted as a surface forming roller that holds the travel position etc. of the intermediate transfer belt 21, the belt support roller 24 is constituted as a tension applying roller that applies tension to the intermediate transfer belt 21, and the belt support roller 25 is constituted as a back-up roller for a second transfer.

As illustrated in FIG. 1, the second transfer device 30 is a contact-type transfer device that includes a second transfer roller 31 that rotates in contact with the peripheral surface of the intermediate transfer belt 21 and that is supplied with a second transfer voltage at a second transfer position as a portion of the outer peripheral surface of the intermediate transfer belt 21 supported by the belt support roller 25. A direct-current voltage that exhibits a polarity opposite to or the same polarity as the charging polarity of the toner is supplied as the second transfer voltage to the second transfer roller 31 or the belt support roller 25 of the intermediate transfer device 20.

The belt cleaning device 26 is composed of: a body 260 in the shape of a partially open container; a cleaning plate 261 disposed in contact with the peripheral surface of the intermediate transfer belt 21 after a second transfer with a prescribed pressure to clean the intermediate transfer belt 21 by removing attached matter such as a residual toner; a feeding member 262 such as a screw auger that recovers the attached matter such as the toner removed by the cleaning plate 261 and that transports and feeds the attached matter to a recovery system (not illustrated); etc. The cleaning plate 261 may be a plate-like member (e.g. a blade) made of a material such as rubber.

As illustrated in FIG. 1, the fixing device 40 is composed of: a heating rotary body 41 in the form of a roller or a belt to be heated by a heating unit such that the surface temperature is kept at a prescribed temperature; a pressurizing rotary body 42 in the form of a roller or a belt to rotate in contact with the heating rotary body 41 with a prescribed pressure substantially along the axial direction of the heating rotary body 41; etc. In the fixing device 40, a contact portion at which the heating rotary body 41 and the pressurizing rotary body 42 contact each other serves as a fixing processing portion at which a prescribed fixing process (heating and pressurizing) is performed. An exit roller 43 that transports the recording paper 5 which has been subjected to the fixing process in the fixing device 40 is disposed at an exit portion of the fixing device 40.

The paper feeding device 50 is disposed at a position under the imaging devices 10 for yellow (Y), magenta (M), cyan (C), and black (K). The paper feeding device 50 is principally composed of: one (or more) paper housing body 51 that stores the recording paper 5 of a desired size, type, etc. in a stacked state; and feeding devices 52 and 53 that feed the recording paper 5, one sheet at a time, from the paper housing body 51. The paper housing body 51 is attached such that the paper housing body 51 may be pulled out toward the side of the front surface (a surface that a user faces during operation) of the apparatus body 1a or the right surface side along a width direction X as in the illustrated example, for example.

Examples of the recording paper 5 include regular paper, thin paper, and overhead projector (OHP) sheets for use in copiers, printers, etc. of an electrophotographic system. In order to further improve the smoothness of an image surface after fixation, the surface of the recording paper 5 is preferably as smooth as possible, and coated paper obtained by coating the surface of regular paper with a resin etc., so-called cardboard with a relatively large basis weight such as art paper for printing, etc. may also be used, for example.

As illustrated in FIG. 1, a paper feeding transport path 55, through which the recording paper 5 fed from the paper feeding device 50 is transported to the second transfer position, is provided between the paper feeding device 50 and the second transfer device 30, the paper feeding transport path 55 being composed of one (or more) paper transport roller pair 54, a transport guide (not illustrated), etc. The paper transport roller pair 54 disposed immediately before the second transfer device 30 is constituted as resist rollers that adjust the transport timing of the recording paper 5, for example. A paper ejection transport path 58 is provided above the fixing device 40 along the vertical direction Z, the paper ejection transport path 58 including a paper ejection roller pair 57 that ejects the recording paper 5 after fixation fed from the exit roller 43 of the fixing device 40 to an ejection tray 56 provided at the upper portion of the apparatus body 1a.

A double-sided printing transport path 60 is provided inside the apparatus body 1a, the double-sided printing transport path 60 including a plurality of double-sided printing transport roller pairs 59 that transport the recording paper 5, on one side of which an image has been formed, to the paper transport roller pair 54 again, with the front and back sides of the recording paper 5 reversed, by switching the rotational direction of the paper ejection roller pair 57 from the forward direction (ejection direction) to the reverse direction while the paper ejection roller pair 57 is holding the rear end of the recording paper 5.

In FIG. 1, reference numeral 61 denotes a manual feed tray provided on a side surface (left side surface in the drawing) of the apparatus body 1a of the image forming apparatus 1 in an openable manner, and a feeding device 62 and a manual feed paper transport path 64 are provided between the manual feed tray 61 and the paper transport roller pair 54, the feeding device 62 feeding the recording paper 5 stored in the manual feed tray 61, one sheet at a time, and the manual feed paper transport path 64 being composed of a paper transport roller pair 63, a transport guide (not illustrated), etc.

In FIG. 1, reference numeral 145 (Y, M, C, K) denotes a plurality of toner cartridges arranged along a direction perpendicular to the drawing sheet surface and storing a developer containing at least a toner to be supplied to the corresponding developing devices 14 (Y, M, C, K).

In FIG. 1, reference numeral 100 denotes a control device that integrally controls operation of the image forming apparatus 1. The control device 100 includes a central processing unit (CPU), a read only memory (ROM), a random access memory (RAM), a bus that connects the CPU, the ROM, etc., a communication interface, etc. (not illustrated).

### <Operation of Image Forming Apparatus>

Basic image forming operation by the image forming apparatus 1 will be described below.

Here, operation to form a full-color image constituted by combining toner images in four colors (Y, M, C, K) using the four imaging devices 10 (Y, M, C, K) will be described.

When the control device 100 of the image forming apparatus 1 receives instruction information that requests image forming operation (printing), the four imaging devices 10 (Y, C, M, K), the intermediate transfer device 20, the second transfer device 30, the fixing device 40, etc. are started.

In each of the imaging devices 10 (Y, M, C, K), first, the photoconductor drum 11 is rotated in the direction indicated by the arrow A, and the charging device 12 charges the surface of the photoconductor drum 11 to a prescribed polarity (negative polarity in the first exemplary embodiment) and potential. Subsequently, the exposure device 13 irradiates the surface of the photoconductor drum 11 after being charged with light emitted on the basis of an image signal, obtained by converting image information input to the image forming apparatus 1 into color components (Y, M, C, K), to form an electrostatic latent image for each color component with a prescribed potential difference on the surface.

Subsequently, each of the imaging devices 10 (Y, M, C, K) develops the electrostatic latent image for each color component formed on the photoconductor drum 11 by supplying a toner for the corresponding color (Y, M, C, K) charged to the prescribed polarity (negative polarity) from the developing roller 141 to the electrostatic latent image and causing the toner to electrostatically adhere to the electrostatic latent image. As a result of this development, the electrostatic latent images for the color components formed on the photoconductor drums 11 are rendered visible as developed toner images in the four colors (Y, M, C, K).

Subsequently, when the toner images in the respective colors formed on the photoconductor drums 11 of the imaging units 10 (Y, M, C, K) are transferred to the first transfer positions, the first transfer devices 15 (Y, M, C, K) perform a first transfer in which the toner images in the respective colors are sequentially superposed on the intermediate transfer belt 21 which rotates in the direction indicated by the arrow B.

In each of the imaging devices 10 (Y, M, C, K) in which a first transfer has been finished, the drum cleaning device 16 cleans the surface of the photoconductor drum 11 by scraping off the attached matter. Consequently, the imaging devices 10 (Y, M, C, K) are rendered ready for the next imaging operation.

Subsequently, in the intermediate transfer device 20, the toner images that have been subjected to a first transfer are held and transported to the second transfer position through rotation of the intermediate transfer belt 21. In the paper feeding device 50, on the other hand, the prescribed recording paper 5 is fed to the paper feeding transport path 55 in accordance with the imaging operation. In the paper feeding transport path 55, the paper transport roller pair 54 as resist rollers feeds and supplies the recording paper 5 to the second transfer position in accordance with the transfer timing.

At the second transfer position, the second transfer roller 31 of the second transfer device 30 performs a second transfer in which the toner images on the intermediate transfer belt 21 are collectively transferred to the recording paper 5. In the intermediate transfer device 20 in which a second transfer has been finished, the belt cleaning device 26 cleans the intermediate transfer belt 21 by removing attached matter such as a residual toner on the surface of the intermediate transfer belt 21 after a second transfer.

Subsequently, the recording paper 5 to which the toner images have been transferred through a second transfer is released from the intermediate transfer belt 21 and the second transfer roller 31, and thereafter transported to the fixing device 40. In the fixing device 40, unfixed toner images are fixed to the recording paper 5 by performing a necessary fixing process (heating and pressurizing) by introducing the recording paper 5 after a second transfer to a contact portion between the heating rotary body 41 and the pressurizing rotary body 42 rotating and causing the recording paper 5 to pass through the contact portion. Finally, the recording paper 5 after the fixation is ejected by the paper ejection roller pair 57 to the ejection tray 56 installed at the upper portion of the apparatus body 1a in image forming operation in which an image is to be formed on only one side of the recording paper 5.

When an image is to be formed on both sides of the recording paper 5, the recording paper 5 on one side of which an image has been formed is not ejected by the paper ejection roller pair 57 to the ejection tray 56, but the rotational direction of the paper ejection roller pair 57 is switched to the reverse direction while the paper ejection roller pair 57 is holding the rear end of the recording paper 5. The recording paper 5 transported in the opposite direction by the paper ejection roller pair 57 is transported to the double-sided printing transport path 60 including the double-sided printing transport roller pair 59 etc., and transported to the paper transport roller pair 54 again with the front and back sides reversed. The paper transport roller pair 54 feeds and supplies the recording paper 5 to the second transfer position in accordance with the transfer timing, and the paper ejection roller pair 57 ejects the recording paper 5, on the back surface of which an image has been formed and to the back surface of which the image has been fixed, to the ejection tray 56 installed at the upper portion of the apparatus body 1a.

Through the above operation, the recording paper 5 on one side or both sides of which a full-color image constituted by combining toner images in four colors has been formed is output.

### <Configuration of Developing Device>

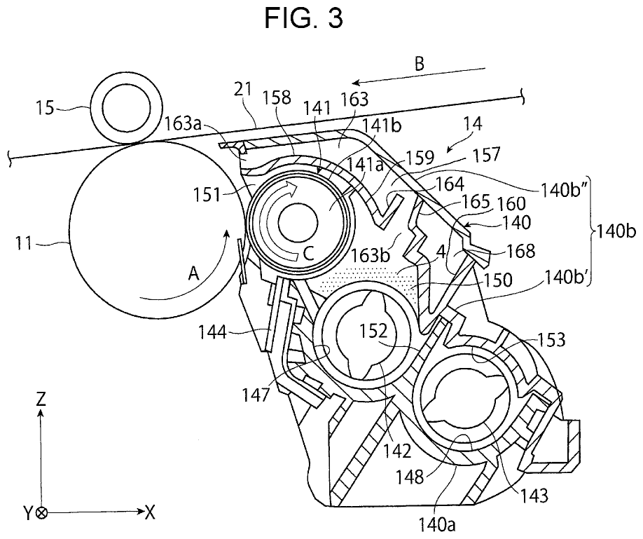

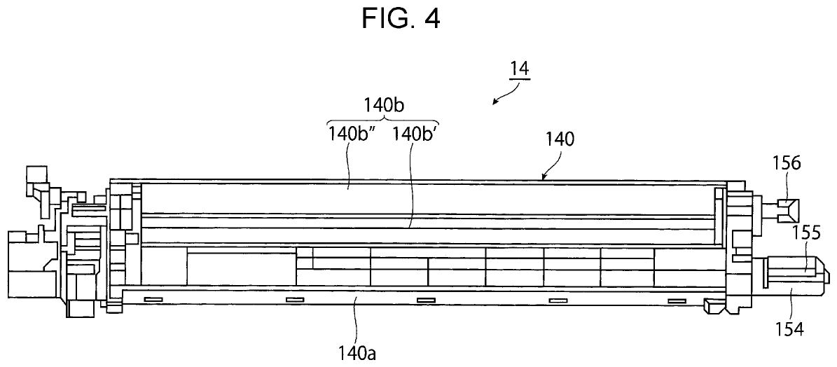

FIGS. 3 and 4 illustrate the developing device according to the first exemplary embodiment applied to the image forming apparatus configured as described above. FIG. 3 is a vertical sectional view illustrating the configuration of the developing device together with the photoconductor drum etc., and FIG. 4 is a back view illustrating the shape of the developing device as seen from the side opposite to the photoconductor drum.

As illustrated in FIG. 3, the developing device 14 includes a device housing 140 as an example of a housing. The device housing 140 roughly includes a lower housing 140a disposed at the lower portion of the developing device 14 along the vertical direction Z, and an upper housing 140b disposed at the upper portion of the developing device 14 along the vertical direction Z. The lower housing 140a and the upper housing 140b are hermetically joined to each other, and a developer storage chamber 150 that stores the two-part developer 4 is formed inside the device housing 140.

In the developing device 14 according to the first exemplary embodiment, the upper housing 140b is not constituted integrally, but is constituted separately from an upper housing body 140b′ that covers the entire upper portion of the developing device 14 and a passage forming member 140b″ that covers the upper end surface of the upper housing body 140b′ to form exhaust passages 163, 163, . . . and suction passages 167, 167, . . . , as discussed later, inside the upper housing body 140b′.

An opening portion 151 is provided at a region of the device housing 140 that faces the photoconductor drum 11. The developing roller 141 as an example of a developer holding unit that rotates while holding the developer 4 is disposed inside the device housing 140 to be rotatable along the direction of an arrow C so as to be partially exposed to the opening portion 151. The developing roller 141 includes a magnet roller 141a as an example of a magnetic field generation unit which is disposed as fixed inside the developing roller 141 and in which a plurality of magnetic poles with a prescribed polarity are disposed at prescribed positions along the circumferential direction, and a cylindrical developing sleeve 141b as an example of a developer transport unit disposed at the outer periphery of the magnet roller 141a to be rotatable at a prescribed rotational speed along the direction of the arrow C. The developing sleeve 141b is formed in a cylindrical shape from a non-magnetic material such as aluminum and non-magnetic stainless steel. The developing sleeve 141b is rotationally driven when a drive force is transmitted from the apparatus body 1a.

In the developing device 14 according to the first exemplary embodiment, the rotational direction C of the developing sleeve 141b is set to a direction opposite to the rotational direction A of the photoconductor drum 11. That is, as illustrated in FIG. 3, the rotational direction C of the developing sleeve 141b is set to the clockwise direction while the rotational direction A of the photoconductor drum 11 is set to the counterclockwise direction. As a result, the outer peripheral surface of the developing sleeve 141b moves in the same direction as the moving direction of the surface of the photoconductor drum 11 in a developing region that faces the photoconductor drum 11.

The rotational speed of the developing sleeve 141b is determined in accordance with the productivity etc. of the image forming apparatus 1 determined by the rotational speed (process speed) of the photoconductor drum 11. The productivity of the image forming apparatus 1 is indicated by the number of sheets of the recording paper 5 of A4 size (long edge feed (LEF)) on which an image may be formed per unit time, for example. The rotational speed (peripheral speed) of the developing sleeve 141b becomes higher as the productivity of the image forming apparatus 1 increases.

An agitation-supply member 142 such as a screw auger (supply auger) that lifts up the developer 4 stored in the developer storage chamber 150 and supplies the developer 4 to the developing roller 141 is disposed inside the device housing 140 and obliquely under the developing roller 141 with respect to the vertical direction. A rotational drive force is transmitted from the developing roller 141 to the agitation-supply member 142 to rotationally drive the agitation-supply member 142 in a prescribed rotational direction. An agitation-transport member 143 such as a screw auger (admix auger) that transports the developer 4 to be supplied to the inside of the device housing 140 while agitating the developer 4 is disposed inside the device housing 140 and obliquely under the agitation-supply member 142. A drive force is transmitted from the agitation-supply member 142 etc. to the agitation-transport member 143 to rotationally drive the agitation-transport member 143 in a prescribed rotational direction.

The lower housing 140a is provided with a first housing portion 147 and a second housing portion 148 formed in a substantially semi-cylindrical cross-sectional shape in order to house the agitation-supply member 142 and the agitation-transport member 143, respectively. The first housing portion 147 and the second housing portion 148 are separated by a partition wall 152 provided in the lower housing 140a. A space above the first housing portion 147 serves as the developer storage chamber 150. The upper housing body 140b′ is provided with a third housing portion 153 formed so as to form a part of a substantially cylindrical cross section to form a transport passage for the developer 4 together with the second housing portion 148 of the lower housing 140a.

First and second passage portions (not illustrated) are provided at both end portions of the partition wall 152 along the longitudinal direction to exchange the developer 4 between the agitation-supply member 142 and the agitation-transport member 143. As illustrated in FIG. 4, an end portion of the agitation-transport member 143 on the deeper side along the axial direction is extended so as to project from the back surface side of the device housing 140. The extended portion of the agitation-transport member 143 is provided with a substantially cylindrical supply portion 154 with a closed end portion. A supply port 155 opens in the substantially cylindrical supply portion 154 to be supplied with the developer 4 for a corresponding color from the toner cartridge 145 (Y, M, C, K). The supply port 155 is covered by a shutter member (not illustrated) in an openable manner.

In FIG. 4, reference numeral 156 denotes a coupling portion that transmits a rotational drive force from the apparatus body 1a side to the developing roller 141.

In the developing device 14 configured as described above, the rotational speed of the developing roller 141 tends to be increased in order to support an improvement in the productivity required of the image forming apparatus 1. When the rotational speed of the developing roller 141 is increased in the developing device 14, as illustrated in FIG. 3, an increased amount of air is taken into the device housing 140 from the opening portion 151 along with rotation of the developing roller 141, increasing the internal pressure of the device housing 140. An end portion of the opening portion 151 of the developing device 14 on the upstream side along the rotational direction of the developing roller 141 is closed by the layer thickness regulation member 144 which regulates the layer thickness of a magnetic brush for the developer 4 held at the outer periphery of the developing sleeve 141b and the magnetic brush for the developer 4.

When the internal pressure of the device housing 140 is increased, a so-called “toner cloud” in which a toner is scattered to the outside from a region of the developing roller 141 that faces the opening portion 151 is caused unless any measures are taken, and the inside of the apparatus body 1a may be soiled with the scattered toner.

Thus, the present applicant already proposed a developing device including: an exhaust passage through which air in a developer storage container is discharged to the outside; a capturing member that captures a toner in the exhaust air passing through the exhaust passage; and a closing member that is held at its base end by the developer storage container and that is sandwiched at its tip by the developer storage container and a developer held by a developer holding body to close a gap on the downstream side of an opening portion along the rotational direction of the developer holding body.

However, it has turned out that the technique disclosed in Japanese Unexamined Patent Application Publication No. 2018-049118 involves a new technical issue that a filter as an example of the capturing member is clogged with a trapped toner over time to suppress air in the developing device being discharged to the outside via the exhaust passage, and that the internal pressure of the developer storage container gradually increases to cause a toner to flow out as a scattered toner from a region of the developer holding body that faces the opening portion.

Regarding such a new technical issue, it is conceivable to dispose a suction duct, through which the scattered toner that leaks from the developing device is sucked, on the back surface side of the developing device along the longitudinal direction.

However, it has been found that when the suction duct is disposed on the back surface side of the developing device, the device housing of the developing device is soiled with a scattered toner that leaks from the front surface side which is away from the suction duct along the longitudinal direction of the developing device, as the scattered toner may not be effectively sucked since the suction duct is away from the opening portion of the developing device, although a scattered toner may be sucked to a certain degree in the vicinity of the suction duct along the longitudinal direction of the developing device.

Regarding such a new technical issue, it is also conceivable to provide, in addition to the exhaust passage, a suction passage, through which the scattered toner that leaks to the outside from the opening portion of the developing device is sucked, over the entire region of the opening portion of the developing device along the axial direction of the developer holding unit, in order to capture the scattered toner that flows out of the opening portion of the developing device.

The suction passage is disposed, in consideration of its function, at an end portion of the opening portion of the developing device on the downstream side along the rotational direction of the developer holding unit, that is, the upper end portion of the developing device along the vertical direction.

However, the intermediate transfer belt 21 of the intermediate transfer device 20 is located at the upper portion of the developing device 14 as discussed above, and therefore the developing device 14 is increased in size when not only the exhaust passage but also the suction passage is disposed at the upper end portion of the developing device 14 along the vertical direction Z, which causes another technical issue that the image forming apparatus 1 is increased in size.

Thus, the developing device according to the first exemplary embodiment includes an exhaust passage through which air in a housing is discharged to the outside and a suction passage through which a developer that leaks out from an opening portion of the housing is sucked, the exhaust passage and the suction passage being disposed at different positions along the axial direction of the developer holding unit.

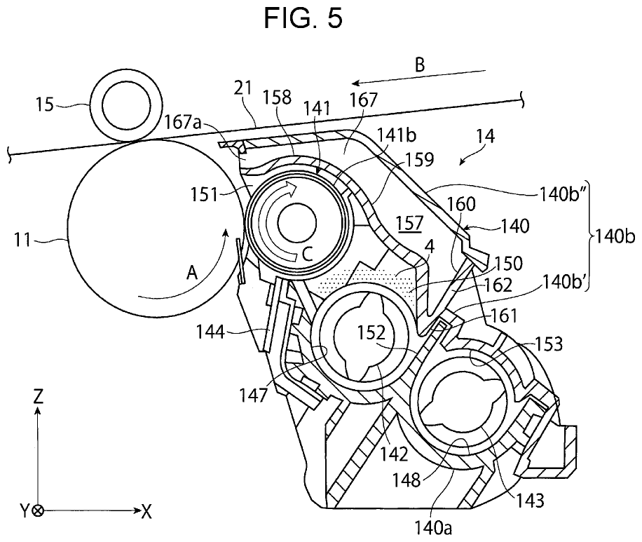

That is, as illustrated in FIG. 5, the developing device 14 according to the first exemplary embodiment has a double structure in which a region of the device housing 140 positioned above the developing roller 141 and the agitation-transport member 142 along the vertical direction Z is sectioned by the upper housing body 140b′ and the passage forming member 140b″, forming a space 157 located between the upper housing body 140b′ and the passage forming member 140b″ and being relatively small in height along the vertical direction Z and relatively long along the horizontal direction X toward the inside of the device housing 140. The space 157 opens over substantially the entire length of the developing roller 141 along the axial direction on the side facing the photoconductor drum 11.

In order to form the space 157, the upper housing body 140b′ of the developing device 14 includes: a cylindrical covering portion 158 that forms a part of a cylindrical shape to cover the outer peripheral surface of the developing roller 141 exposed to the outside at an end portion of the opening portion 151 on the downstream side along the rotational direction C of the developing roller 141; a curved portion 159 curved obliquely downward from the back surface side of the cylindrical covering portion 158 toward a location above the agitation-supply member 142; and a bent portion 160 bent further downward in a substantially V-shape from the back surface side of the curved portion 159. A recessed portion 161 joined to the partition wall 152 of the lower housing 140a is provided at the lower end portion of the bent portion 160. A side wall 162 of the bent portion 160 on the back surface side is extended to the upper end portion of the device housing 140. The side wall 162 on the back surface side is joined to the passage forming member 140b″ to form the space 157.

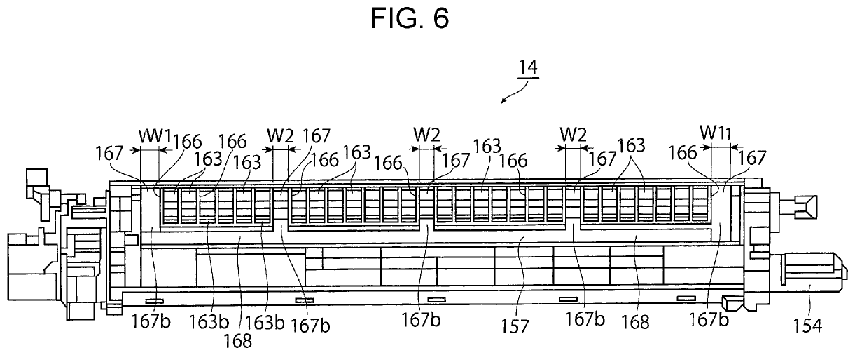

As illustrated in FIGS. 3 and 6, the exhaust passages 163, 163, . . . through which air inside the device housing 140 is to be discharged to the outside are formed between the upper housing body 140b′ and the passage forming member 140b″ by partitioning a part of the space 57.

It is desirable that inside air should be discharged to the outside through the exhaust passages 163, 163, . . . over substantially the entire region of the developing device 14 along the axial direction of the developing roller 141, in order to suppress an increase in the internal pressure of the developing device 14. The exhaust passages 163, 163, . . . are disposed at the upper portion of the developing device 14 along the vertical direction Z, that is, at an end portion of the opening portion 151 of the device housing 140 on the downstream side along the rotational direction of the developing roller 141, and on the intermediate transfer belt 21 side which is the same position as the suction passages 167, 167, . . . to be discussed later, in consideration of the necessity to discharge air that is present inside the device housing 140 of the developing device 14 and above the developer storage chamber 150 along the vertical direction Z.

A plurality of exhaust passages 163, 163, . . . are disposed along the axial direction of the developing roller 141. As illustrated in FIG. 3, exit-side end portions 163a of the exhaust passages 163, 163, . . . open at an end portion of the opening portion 151 of the device housing 140 on the downstream side along the rotational direction C of the developing roller 141. Entrance-side end portions 163b of the exhaust passages 163, 163, . . . open at the curved portion 159 of the upper housing body 140b′.

The entrance-side end portions 163b of the exhaust passages 163, 163, . . . are surrounded by a separation wall 164 provided to stand at the curved portion 159 of the upper housing body 140b′ so as to intersect the longitudinal direction of the exhaust passages 163, 163, . . . . The separation wall 164 opens at a position proximate to the inner surface of the passage forming member 140b″, and constitutes the entrance-side end portions 163b of the exhaust passages 163, 163, . . . . The separation wall 164 suppresses the toner in the developer storage chamber 150 flowing out.

A side wall 165 on the back surface side of the separation wall 164 extends to the upper end portion of the device housing 140. The side wall 165 of the separation wall 164 is joined to the passage forming member 140b″ to define the exhaust passages 163, 163, . . . . As illustrated in FIG. 6, adjacent exhaust passages 163, 163, . . . are separated from each other by division walls 166.

As illustrated in FIGS. 3 and 6, the suction passages 167, 167, . . . through which a toner as an example of the developer that leaks to the outside from the opening portion 151 of the device housing 140 is to be sucked are formed between the upper housing body 140b′ and the passage forming member 140b″ by partitioning a part of the space 157. A plurality of suction passages 167, 167, . . . are disposed so as to be all located at positions different from the exhaust passages 163, 163, . . . along the axial direction of the developing roller 141.

The suction passages 167, 167, . . . suck a scattered toner that flows out of the opening portion 151 of the developing device 14 to the outside, and desirably suck a scattered toner that flows out over substantially the entire region of the developing device 14 along the axial direction of the developing roller 141. The suction passages 167, 167, . . . are disposed at an end portion of the opening portion 151 of the developing device 14 on the downstream side along the rotational direction of the developing roller 141, that is, on the intermediate transfer belt 21 side at the upper portion of the developing device 14 along the vertical direction Z, because the suction passages 167, 167, . . . suck a scattered toner that flows out of the opening portion 151 of the developing device 14 to the outside.

As illustrated in FIG. 5, entrance-side end portions 167a of the suction passages 167, 167, . . . open at an end portion of the opening portion 151 of the device housing 140 on the downstream side along the rotational direction of the developing roller 141. That is, the suction passages 167, 167, . . . open at an end portion of the opening portion 151 of the device housing 140 on the downstream side along the rotational direction of the developing roller 141, that is, at the same position as the exhaust passages 163, 163, . . . . As illustrated in FIG. 6, exit-side end portions 167b of the suction passages 167, 167, . . . are disposed inside the device housing 140.

The end portions 167b of the suction passages 167, 167, . . . inside the device housing 140 are communicably joined to a communication path 168 disposed along the axial direction of the developing roller 141.

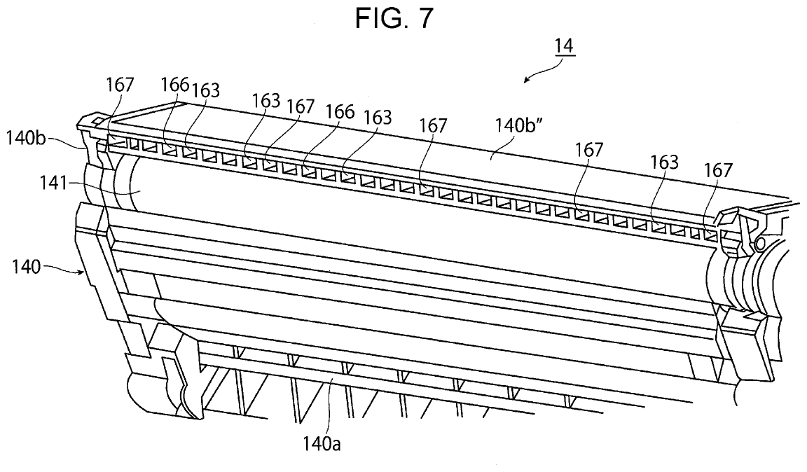

As illustrated in FIGS. 6 and 7, when the exhaust passages 163, 163, . . . are formed at the upper portion of the upper housing body 140b′, the suction passages 167, 167, . . . are eventually formed as passages as the remainder of the space 157, separated from the exhaust passages 163, 163, . . . . That is, passage regions of the space 157 left after the exhaust passages 163, 163, . . . are defined form the suction passages 167, 167, . . . .

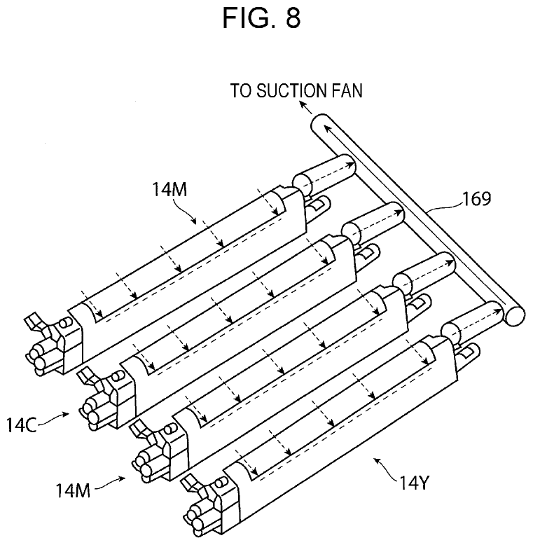

As illustrated in FIG. 3, the communication path 168 is constituted as a passage-like space, of the space 157, positioned above an end portion of the curved portion 159 of the upper housing body 140b′ on the back surface side and the bent portion 160. The communication path 168 is extended to an end portion of the developing device 14 on the back surface side, and connected to a suction fan (not illustrated) as an example of a suction unit via a suction duct 169 as illustrated in FIG. 8. A filter that removes a toner is provided at an exhaust port of the suction fan.

In the developing device 14 according to the first exemplary embodiment, as discussed above, the exhaust passages 163, 163, . . . and the suction passages 167, 167, . . . are all disposed at different positions along the axial direction of the developing roller 141. That is, the exhaust passages 163, 163, . . . and the suction passages 167, 167, . . . are not provided at the same position along the axial direction of the developing roller 141.

As illustrated in FIGS. 6 and 7, the suction passages 167, 167, . . . are disposed at both end portions of the developing roller 141 along the axial direction and at positions determined by equally dividing the interval between the two end portions by N (here, N is 4). The interval between the suction passage 167 positioned at an end portion of the developing roller 141 on the front side along the axial direction and an adjacent suction passage 167, of the suction passages 167, 167, . . . , is set to be slightly shorter than the intervals between the other suction passages 167.

While an opening width W1 of the suction passages 167, 167 positioned at both end portions of the developing roller 141 along the axial direction is set to be larger than an opening width W2 of the other suction passages 167, 167, . . . in the illustrated example, the opening width W1 of the suction passages 167, 167 positioned at both end portions may be set to be equal to or smaller than the opening width W2 of the other suction passages 167, 167, . . . . [0117] In the developing device 14 according to the first exemplary embodiment, as illustrated in FIG. 6, the exhaust passages 163, 163, . . . are disposed at positions other than the positions of the suction passages 167, 167, . . . along the axial direction of the developing roller 141, that is, at positions adjacent to the suction passages 167, 167, . . . positioned at both end portions of the developing roller 141 along the axial direction and the suction passages 167, 167, . . . at intermediate positions.

While adjacent exhaust passages 163, 163, . . . are separated from each other by the division walls 166 in FIG. 6, adjacent exhaust passages 163, 163, . . . may be formed as a continuous exhaust passage 163, rather than being separated by the division walls 166. When adjacent exhaust passages 163, 163, . . . are separated from each other by the division walls 166, exhaust air from the exhaust passages 163, 163, . . . may be directed in a direction intersecting the axial direction of the developing roller 141.

### <Function of Developing Device>

With the developing device according to the first exemplary embodiment configured as described above, it is possible to discharge air in the developing device and suction a scattered toner at the same time, while avoiding an increase in size of the developing device, compared to a case where the exhaust passages and the suction passages are all disposed at the same position along the axial direction of the developer holding unit, as follows.

That is, in the image forming apparatus 1 including the developing device 14 according to the first exemplary embodiment, as illustrated in FIGS. 1 and 2, an electrostatic latent image is formed on the surface of the photoconductor drum 11 in each of the imaging devices 10 (Y, M, C, K), and the electrostatic latent image formed on the surface of the photoconductor drum 11 is developed by the corresponding developing device 14.

In the developing device 14, as illustrated in FIG. 3, the developing roller 141, the agitation-supply member 142, and the agitation-transport member 143 are rotationally driven in a prescribed rotational direction, and the electrostatic latent image on the surface of the photoconductor drum 11 is rendered visible and developed using a toner by a magnetic brush for the developer 4 held on the surface of the developing sleeve 141b of the developing roller 141.

In the developing device 14, as illustrated in FIG. 3, the developing roller 141 is rotationally driven at a prescribed speed along the direction of the arrow C, and therefore the internal pressure tends to be increased with outside air introduced to the inside of the device housing 140 through the opening portion 151 along with rotation of the developing roller 141.

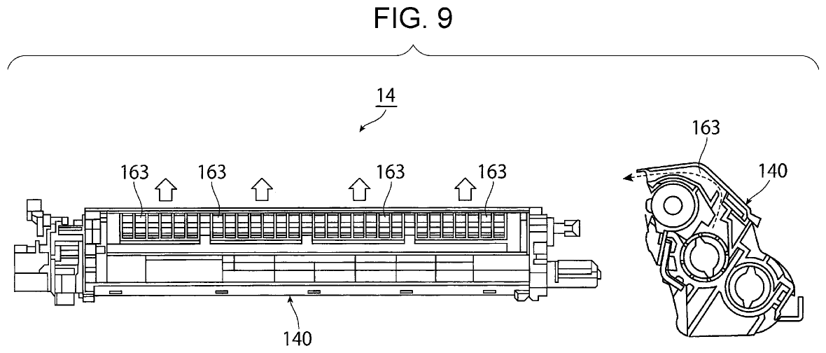

As illustrated in FIG. 9, the developing device 14 according to the first exemplary embodiment includes a plurality of exhaust passages 163, 163, . . . provided along the axial direction of the developing roller 141, and therefore air in the device housing 140 is discharged to the outside via the exhaust passages 163, 163, . . . .

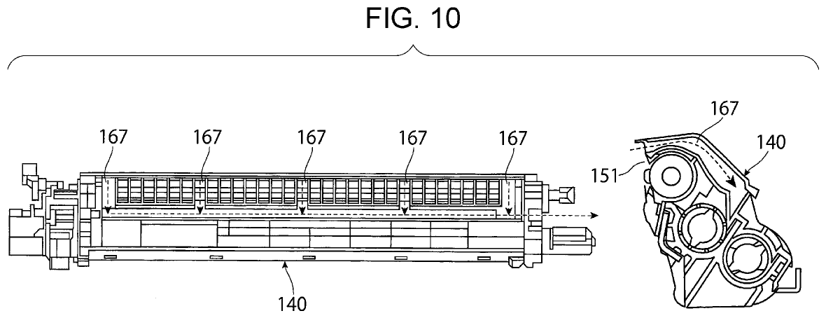

As illustrated in FIG. 10, the developing device 14 according to the first exemplary embodiment includes a plurality of suction passages 167, 167, . . . provided along the axial direction of the developing roller 141. Therefore, even when there is a possibility that a toner leaks out of the developing device 14 through the opening portion 151 of the device housing 140 or the exhaust passages 163, 163, . . . , the toner to leak out through the opening portion 151 or the exhaust passages 163, 163, . . . may be sucked through the plurality of suction passages 167, 167, . . . .

In the developing device 14 according to the first exemplary embodiment, as illustrated in FIGS. 6 and 7, the plurality of exhaust passages 163, 163, . . . and the plurality of suction passages 167, 167, . . . are all disposed at different positions along the axial direction of the developing roller 141.

As a result, it is not necessary to dispose the exhaust passages 163, 163, . . . and the suction passages 167, 167, . . . in a so-called two-storied structure at the same position along the axial direction of the developing roller 141, that is, at the upper portion of the device housing 140 along the vertical direction Z, even in the case where a plurality of exhaust passages 163, 163, . . . and a plurality of suction passages 167, 167, . . . are disposed in the developing device 14 at the upper portion of the device housing 140 along the vertical direction Z, which is an end portion of the opening portion 151 of the device housing 140 on the downstream side along the rotational direction of the developing roller 141.

### Second Exemplary Embodiment

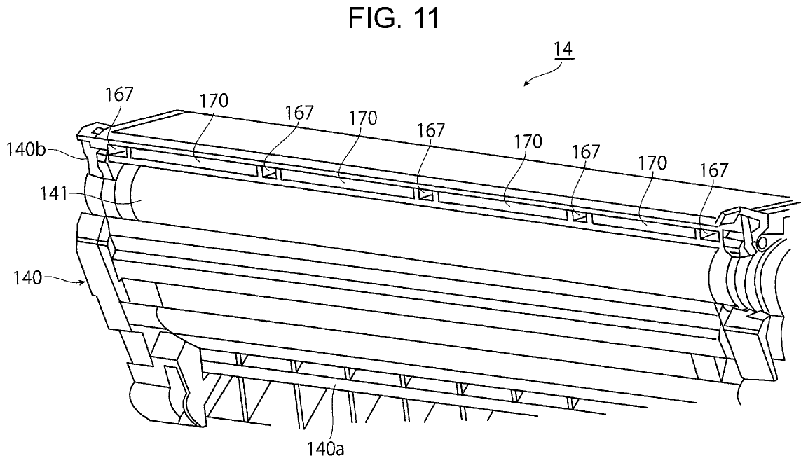

FIG. 11 illustrates the configuration of a developing device according to a second exemplary embodiment of this disclosure.

As illustrated in FIG. 11, the developing device 14 according to the second exemplary embodiment is configured such that the exit-side end portions 163a of the exhaust passages 163, 163, . . . are all closed by filter members 170 as examples of a capture unit. The exit-side end portions 163a of the exhaust passages 163, 163, . . . are provided with the filter members 170 through adhesion etc.

The other components and functions are the same as those according to the first exemplary embodiment, and thus are not described.

### Third Exemplary Embodiment

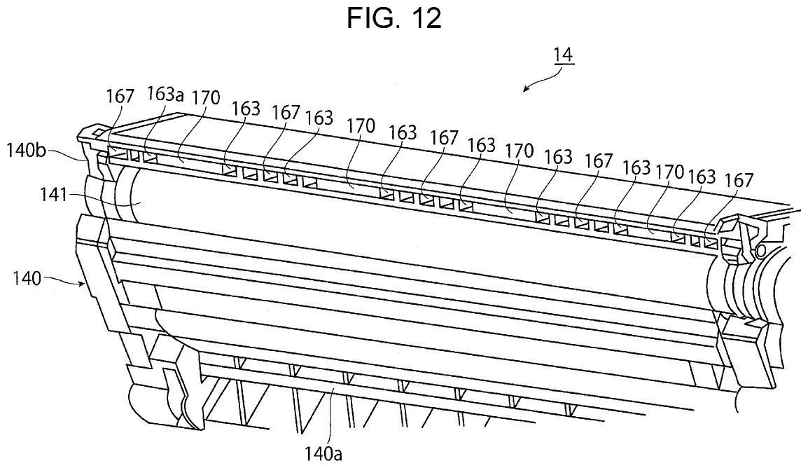

FIG. 12 illustrates the configuration of a developing device according to a third exemplary embodiment of this disclosure.

The developing device 14 according to the third exemplary embodiment is configured such that some of the exit-side end portions 163a of the exhaust passages 163, 163, . . . are closed by the filter members 170 as examples of a capture unit, rather than the exit-side end portions 163a of the exhaust passages 163, 163, . . . are all closed by the filter members 170 as examples of a capture unit.

That is, in the developing device 14 according to the third exemplary embodiment, as illustrated in FIG. 12, the exit-side end portions 163a of one or more exhaust passages 163, 163, . . . adjacent to the suction passages 167, 167, . . . are left open, and the exit-side end portions 163a of exhaust passages 163, 163, . . . not adjacent to the suction passages 167, 167, . . . are closed by the filter members 170.

The other components and functions are the same as those according to the first exemplary embodiment, and thus are not described.

### Fourth Exemplary Embodiment

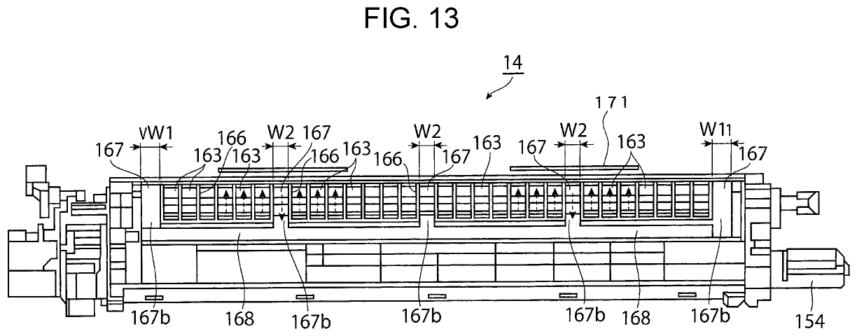

FIG. 13 illustrates the configuration of a developing device according to a fourth exemplary embodiment of this disclosure.

The developing device according to the fourth exemplary embodiment is configured such that the suction passages are provided at a plurality of locations including both end portions and a middle portion of the developer holding unit along the axial direction, and exhaust passages adjacent to the suction passages disposed at positions excluding the two end portions and the middle portion of the developer holding unit along the axial direction are closed.

The developing device according to the fourth exemplary embodiment is configured such that some of the exhaust passages along the axial direction of the developer holding unit are closed, and the closed exhaust passages communicate with the suction passages.

That is, in the developing device 14 according to the fourth exemplary embodiment, as illustrated in FIG. 13, the suction passages 167, 167, . . . positioned at both end portions and a middle portion of the developing roller 141 along the axial direction are opened. The suction passages 167, 167 disposed at positions other than the two end portions and the middle portion of the developing roller 141 along the axial direction are closed by shield plates 171.

The exhaust passages 163, 163, . . . are configured such that the suction passages 167, 167 closed by the shield plates 171 and a plurality of exhaust passages 163, 163, . . . adjacent on both sides to the suction passages 167, 167 are closed by the same shield plates 171, and the plurality of closed exhaust passages 163, 163, . . . communicate at the exit-side end portions with the closed suction passages 167, 167 via a void.

While the shield plates 171 are illustrated as being spaced from the exhaust passages 163, 163, . . . and the suction passages 167, 167 for convenience in FIG. 13, the shield plates 171 are fixed to the device housing 140 through adhesion etc. to close the exhaust passages 163, 163, . . . and the suction passages 167, 167.

The other components and functions are the same as those according to the first exemplary embodiment, and thus are not described.

While the present disclosure is applied to a full-color image forming apparatus in the above exemplary embodiments, the present disclosure is also similarly applicable to a monochrome image forming apparatus as a matter of course.

While the suction passages are disposed at five locations along the axial direction of the developer holding body in the above exemplary embodiments, the number and the arrangement of the suction passages may be determined as desired, and the suction passages may be disposed at more or less than five locations as a matter of course.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A developing device comprising:
a housing that stores a developer;
a developer holding unit that is disposed at an opening portion of the housing that faces an image holding body and that rotates while holding the developer;
an exhaust passage through which air in the housing is discharged to outside; and
a suction passage through which the developer that leaks out from the opening portion of the housing is sucked,
wherein the exhaust passage and the suction passage are disposed at different positions along an axial direction of the developer holding unit.
   (((2)))

The developing device according to (((1))),
wherein the suction passage is disposed downstream of the opening portion of the housing along a rotational direction of the developer holding unit.
   (((3)))

The developing device according to (((1))),
wherein the exhaust passage is disposed at an upper portion of the housing along a vertical direction.
   (((4)))

The developing device according to (((3))),
wherein the exhaust passage is disposed downstream of the opening portion of the housing along a rotational direction of the developer holding unit and at a same position as the suction passage as seen in a direction of a rotational axis of the developer holding unit.
   (((5)))

The developing device according to (((1))),
wherein the suction passage is disposed at at least both end portions of the developer holding unit along the axial direction.
   (((6)))

The developing device according to (((5))),
wherein an additional suction passage is disposed between the suction passages disposed at the both end portions of the developer holding unit along the axial direction.
   (((7)))

The developing device according to (((6))),
wherein the suction passage is disposed at each of positions determined by equally dividing the developer holding unit by N (N is an integer of 2 or more) along the axial direction.
   (((8)))

The developing device according to (((5))),
wherein the exhaust passage is disposed at positions of the developer holding unit other than positions of the suction passages along the axial direction.
   (((9)))

The developing device according to (((1))),
wherein the exhaust passage includes a capture unit provided at an exit portion of the exhaust passage to capture the developer that leaks out through the exhaust passage.
   (((10)))

The developing device according to (((9))),
wherein the developing device comprises a plurality of exhaust passages each serving as the exhaust passage, and
wherein the capture unit is provided for each of the exhaust passages.
   (((11)))

The developing device according to (((9))),
wherein the exhaust passage is one of a plurality of exhaust passages of the developing device, and
the capture unit is provided for each of exhaust passages other than the exhaust passages adjacent to the suction passage.
   (((12)))

The developing device according to (((1))),
wherein the developing device comprises a plurality of exhaust passages each serving as the exhaust passage,
some exhaust passages disposed along the axial direction of the image holding unit are closed, and
the closed exhaust passages communicate with the suction passage.
   (((13)))

The developing device according to (((12))),
wherein the suction passage is provided at a plurality of locations including both end portions and a middle portion of the developer holding unit along the axial direction, and
exhaust passages adjacent to suction passages disposed at positions excluding the both end portions and the middle portion of the developer holding unit along the axial direction are closed.
   (((14)))

An image forming apparatus comprising:
an image holding unit that holds an electrostatic latent image; and
a developing unit that develops the electrostatic latent image on the image holding unit,
wherein the developing device according to any one of (((1))) to (((13))) is used as the developing unit.

What is claimed is:

1. A developing device comprising:
a housing that stores a developer;
a developer holding unit that is disposed at an opening portion of the housing that faces an image holding body and that rotates while holding the developer;
an exhaust passage through which air in the housing is discharged to outside; and
a suction passage through which the developer that leaks out from the opening portion of the housing is sucked,
wherein the exhaust passage and the suction passage are disposed at different positions along an axial direction of the developer holding unit.

2. The developing device according to claim 1,
wherein the suction passage is disposed downstream of the opening portion of the housing along a rotational direction of the developer holding unit.

3. The developing device according to claim 1,
wherein the exhaust passage is disposed at an upper portion of the housing along a vertical direction.

4. The developing device according to claim 3,
wherein the exhaust passage is disposed downstream of the opening portion of the housing along a rotational direction of the developer holding unit and at a same position as the suction passage as seen in a direction of a rotational axis of the developer holding unit.

5. The developing device according to claim 1,
wherein the suction passage is disposed at at least both end portions of the developer holding unit along the axial direction.

6. The developing device according to claim 5,
wherein an additional suction passage is disposed between the suction passages disposed at the both end portions of the developer holding unit along the axial direction.

7. The developing device according to claim 6,
wherein the suction passage is disposed at each of positions determined by equally dividing the developer holding unit by N (N is an integer of 2 or more) along the axial direction.

8. The developing device according to claim 5,
wherein the exhaust passage is disposed at positions of the developer holding unit other than positions of the suction passages along the axial direction.

9. The developing device according to claim 1,
wherein the exhaust passage includes a capture unit provided at an exit portion of the exhaust passage to capture the developer that leaks out through the exhaust passage.

10. The developing device according to claim 9,
wherein the developing device comprises a plurality of exhaust passages each serving as the exhaust passage, and
wherein the capture unit is provided for each of the exhaust passages.

11. The developing device according to claim 9,
wherein the exhaust passage is one of a plurality of exhaust passages of the developing device, and
the capture unit is provided for each of exhaust passages other than the exhaust passages adjacent to the suction passage.

12. The developing device according to claim 1,
wherein the developing device comprises a plurality of exhaust passages each serving as the exhaust passage,
some exhaust passages disposed along the axial direction of the image holding unit are closed, and
the closed exhaust passages communicate with the suction passage.

13. The developing device according to claim 12,
wherein the suction passage is provided at a plurality of locations including both end portions and a middle portion of the developer holding unit along the axial direction, and
exhaust passages adjacent to suction passages disposed at positions excluding the both end portions and the middle portion of the developer holding unit along the axial direction are closed.

14. An image forming apparatus comprising:
an image holding unit that holds an electrostatic latent image; and
a developing unit that develops the electrostatic latent image on the image holding unit,
wherein the developing device according to claim 1 is used as the developing unit.

15. An image forming apparatus comprising:
an image holding unit that holds an electrostatic latent image; and
a developing unit that develops the electrostatic latent image on the image holding unit,
wherein the developing device according to claim 2 is used as the developing unit.

16. An image forming apparatus comprising:
an image holding unit that holds an electrostatic latent image; and
a developing unit that develops the electrostatic latent image on the image holding unit,
wherein the developing device according to claim 3 is used as the developing unit.

17. An image forming apparatus comprising:
an image holding unit that holds an electrostatic latent image; and
a developing unit that develops the electrostatic latent image on the image holding unit,
wherein the developing device according to claim 4 is used as the developing unit.

18. An image forming apparatus comprising:
an image holding unit that holds an electrostatic latent image; and
a developing unit that develops the electrostatic latent image on the image holding unit,
wherein the developing device according to claim 5 is used as the developing unit.

19. An image forming apparatus comprising:
an image holding unit that holds an electrostatic latent image; and
a developing unit that develops the electrostatic latent image on the image holding unit,
wherein the developing device according to claim 6 is used as the developing unit.

20. An image forming apparatus comprising:
an image holding unit that holds an electrostatic latent image; and
a developing unit that develops the electrostatic latent image on the image holding unit,
wherein the developing device according to claim 7 is used as the developing unit.
